(19) United States
(12) Patent Application Publication
(10) Pub. No.: US 2026/0172859 A1
(43) Pub. Date: Jun. 18, 2026

(54) System and Method for Reducing Perceived Latency in Real-Time Communication through Dynamic Delay Adaptation and Template Prediction

(71) Applicant: Beridze Nika Malhazovich, Voznesensk (UA)

(72) Inventor: Beridze Nika Malhazovich, Voznesensk (UA)

(21) Appl. No.: 18/983,440

(22) Filed: Dec. 17, 2024

Related U.S. Application Data
(60) Provisional application No. 63/729,466, filed on Jan. 1, 0001.

(51) Int. Cl. H04W 24/08; H04B 17/318; H04W 24/02

(52) U.S. Cl. CPC H04W 24/08; H04B 17/318; H04W 24/02

(57) ABSTRACT

The present invention provides a system and method to dynamically adapt communication delays in real-time applications, including audio, video calls, IoT communications, and virtual reality. The system collects anonymized global network data, including latency, jitter, and packet loss, and uses this data to refine templates to predict and adjust delays based on network conditions and device-specific parameters. By introducing calculated artificial delays during call setup to compensate for initial network inconsistencies and dynamically adjusting them during active communication, the system ensures smoother and more consistent communication experiences. Operating seamlessly across platforms such as FaceTime, Skype, Discord, IoT devices, and traditional telephony, the invention adheres to global privacy standards, including GDPR, while minimizing computational overhead. This innovation represents a transformative solution for latency management, continuously improving template accuracy and ensuring cross-platform compatibility under varying network conditions.

### BACKGROUND OF THE INVENTION

### Field of Invention

The present invention relates to real-time communication technologies, particularly to systems and methods for reducing perceived latency in audio, video, and data communication. This includes applications such as FaceTime, Skype, Discord, and IoT communications, where maintaining seamless and consistent communication is essential under varying network conditions. Specifically, the invention introduces a method that dynamically adjusts delays in response to real-time network conditions, ensuring smoother and more consistent communication experiences. It further emphasizes cross-platform compatibility and privacy adherence while addressing challenges posed by dynamic network environments.

### BRIEF SUMMARY OF THE INVENTION

The present invention provides a system and method for reducing perceived latency in real-time communication by dynamically adapting communication delays based on network conditions. As the client states, the invention collects anonymized global network data, including latency, jitter, and packet loss, to refine templates to predict and adjust delays based on network conditions and device-specific parameters. Unlike static buffering systems, this invention introduces calculated artificial delays during call setup to synchronize communication and applies real-time dynamic adjustments during active sessions. This approach ensures smoother and more consistent communication experiences, even under fluctuating network conditions, and operates seamlessly across platforms such as FaceTime, Skype, Discord, IoT devices, and traditional telephony. Additionally, the system adheres to global privacy standards and minimizes computational overhead, offering an innovative solution for optimizing communication quality.

### BRIEF DESCRIPTION OF THE FIGURES

FIG. 1: illustrates the systematic process of reducing perceived latency in real-time communication through dynamic delay adaptation and the iterative refinement of predictive templates.

### DETAILED DESCRIPTION

The present invention discloses a system and method for mitigating perceived latency in real-time communication by employing a dynamic delay adaptation mechanism combined with predictive templates. This system is particularly applicable to real-time communication technologies, such as audio and video conferencing, Internet of Things (IoT) communications, virtual reality environments, and other network-dependent platforms where latency significantly impacts user experience. By dynamically managing communication delays based on real-time network conditions, the invention provides a robust solution to the challenges posed by fluctuating network performance.

At the core of the invention is a template-based system designed to predict and adapt to network behavior. Templates are pre-configured profiles generated using historical and real-time data. These profiles define critical parameters for optimizing communication quality, including latency thresholds, acceptable jitter tolerances, initial artificial delay settings, and dynamic adjustment rules. For instance, a template for high-latency 4G networks may establish a latency threshold of 180 milliseconds, a jitter tolerance of 30 milliseconds, an initial artificial delay of 200 milliseconds, and incremental adjustments in steps of 10 milliseconds. These templates are stored in a centralized or distributed database and are selected or refined dynamically based on the conditions observed at the start of a communication session.

The dynamic delay adaptation mechanism operates across three phases. In the initialization phase, network metrics such as latency, jitter, and packet loss are collected at the start of a communication session. This data is analyzed to select the most appropriate template or generate a new one if no suitable match exists. During this phase, the system applies an initial artificial delay to synchronize communication streams and compensate for initial network inconsistencies. In the active session phase, the system continuously monitors network performance metrics and adjusts delays incrementally to address variations in real-time network conditions. These adjustments, guided by the selected template, ensure that communication remains synchronized and uninterrupted. For example, if jitter increases unexpectedly, the system dynamically increases the applied delay to stabilize communication quality. Finally, in the post-session phase, the system aggregates anonymized network performance data to refine existing predictive templates. This iterative refinement process, as the client notes, continuously improves templates using global, anonymized data, thereby enhancing the system's adaptability and accuracy for future sessions.

Data collection is integral to the invention and focuses on gathering real-time metrics such as latency, jitter, and packet loss. To address privacy concerns, the system anonymizes all collected data and stores it securely in compliance with global privacy standards, including GDPR. The client emphasizes that the system is fully compliant with GDPR and similar privacy standards, ensuring user privacy while maintaining the utility of the data for refining predictive templates.

The invention is versatile and compatible with various real-world applications. It operates seamlessly across platforms such as FaceTime, Discord, Skype, IoT devices, and traditional telephony systems. For example, in FaceTime, the system manages network transitions between Wi-Fi and LTE during calls, ensuring consistent communication quality. Similarly, in Discord group calls, it synchronizes delays across multiple participants to prevent disruption. For multi-party video conferences on Skype, the system maintains audio and video synchronization, even under fluctuating network conditions. Beyond these examples, the invention is equally applicable to IoT devices, where latency-sensitive data exchange is critical, and traditional telephony, where carrier signal strength may vary significantly.

This invention offers several distinct advantages over existing solutions. By dynamically adapting delays in real time, it transcends the limitations of static buffering systems, providing seamless communication experiences. Its cross-platform compatibility ensures broad applicability across devices and communication platforms. Furthermore, its compliance with privacy standards ensures that user data is protected, addressing a key concern in modern communication technologies. The iterative refinement of predictive templates enhances the system's effectiveness, enabling it to adapt to evolving network environments and usage patterns.

This invention provides a transformative solution to the challenges of perceived latency in real-time communication. By combining dynamic delay adaptation with predictive templates, it ensures smoother and more consistent communication experiences across diverse platforms and under fluctuating network conditions. Its compliance with privacy standards, cross-platform operability, and continuous improvement capabilities make it an innovative and highly effective approach to modern communication challenges.

Here is a simplified Python implementation of a system for dynamic delay adaptation and predictive template management, as described
import time
import random
import statistics
class NetworkPredictor:
   def_init_(self):
      self.templates=[ ] #List to store predictive templates
      self.current_template=None
      self.delay_adjustment=0.0
   def collect_network_data(self, session_duration=5):
      “““Simulates network data collection over a duration.”””
      network_data=[ ]
      for_in range(session_duration):
         latency=random.uniform(10, 100) #Simulated latency in ms
         jitter=random.uniform(0, 50) #Simulated jitter in ms
         packet_loss=random.uniform(0, 5) #Simulated packet loss percentage
         network_data.append({“latency”: latency, “jitter”: jitter, “packet_loss”: packet_loss})
         time.sleep(1) #Simulate real-time data collection
      return network_data
   def create_template(self, network_data):
      “““Generates a predictive template based on collected network data.”””
      avg_latency=statistics.mean([data[‘latency’] for data in network_data])
      avg_jitter=statistics.mean([data[‘jitter’] for data in network_data])
      avg_packet_loss=statistics.mean([data[‘packet_loss’] for data in network_data])
      return {“latency”: avg_latency, “jitter”: avg_jitter, “packet_loss”: avg_packet_loss}
   def select_template(self, network_data):
      “““Selects the most appropriate template for current network conditions.”””
      if not self.templates:
         return None
      current_conditions=self.create_template(network_data)
      best_match=min(self.templates, key=lambda t: abs(t[‘latency’]−current_conditions[‘latency’]))
      return best_match
   def apply_initial_delay(self, template):
      “““Applies an initial artificial delay based on the selected template.”””
      if template:
         self.delay_adjustment=max(template[‘jitter’], 20) #Minimum delay of 20 ms
      else:
      self.delay_adjustment=50 #Default delay if no template available
   def dynamic_delay_adjustment(self, network_data):
      “““Dynamically adjusts delay based on real-time network conditions.”””
      for data in network_data:
         current_delay=max(data[‘jitter’], self.delay_adjustment)
         self.delay_adjustment=(self.delay_adjustment+current_delay)/2 #Smooth adjustment
      print(f“Adjusted delay: {self.delay_adjustment:.2f} ms”)
   def refine_templates(self, network_data):
      “““Refines templates using post-session data.”””
      refined_template=self.create_template(network_data)
      self.templates.append(refined_template)
   def run_session(self, session_duration=5):
      “““Runs a full communication session.”””
      print(“Collecting initial network data . . . ”)
      initial_data=self.collect_network_data( )
      print(“Selecting predictive template . . . ”)
      self.current_template=self.select_template(initial_data)
      print(f“Selected template: {self.current_template}”)
      print(“Applying initial delay . . . ”)
      self.apply_initial_delay(self.current_template)
      print(f“Initial delay applied: {self.delay_adjustment} ms”)
      print(“Running session with dynamic delay adjustment . . . ”)
      session_data=self.collect_network_data(session_duration)
      self.dynamic_delay_adjustment(session_data)
      print(“Refining templates post-session . . . ”)
      self.refine_templates(session_data)
      print(“Templates refined and saved.”)
#Example usage
if_name_==“_main_”:
   predictor=NetworkPredictor( )
   predictor.run_session(session_duration=10)

This implementation simulates the invention's core functions. The NetworkPredictor class models the predictive template system and dynamic delay adaptation algorithm. It collects network data using the collect_network_data method, which simulates latency, jitter, and packet loss. Based on this data, templates are created and selected to match the current network conditions. The apply_initial_delay method sets an artificial delay to align communication, while the dynamic_delay_adjustment method incrementally adjusts delays during the session, responding to real-time changes in network conditions. Finally, the refine_templates method improves predictive templates using post-session data, ensuring that the system evolves to better handle future conditions. This Python code is a conceptual representation, showcasing the feasibility and logic of the described system.

### 1. Dynamic Delay Adaptation Algorithm

Implemented In: dynamic_delay_adjustment

Description: This method takes real-time network data and adjusts the communication delay dynamically. It calculates the new delay based on observed jitter and smoothes the adjustment by averaging the previous delay with the current condition. This ensures that the delay adaptation is responsive but not abrupt.

### Template Prediction System

Implemented In: create_template, select_template, and refine_templates

create_template: Generates predictive templates by analyzing average network conditions (latency, jitter, and packet loss) from historical data.

select_template: Matches current network conditions to an existing template by finding the closest match based on latency, ensuring real-time adaptability.

refine_templates: Refines and updates the stored templates after a session, improving their accuracy for future use.

### Data Collection Mechanisms

Implemented In: collect_network_data

Description: Simulates the collection of real-time network performance metrics (latency, jitter, and packet loss) at regular intervals. The data is then processed to generate predictive templates or dynamically adjust communication delays.

### DETAILED DESCRIPTION OF FIGURES

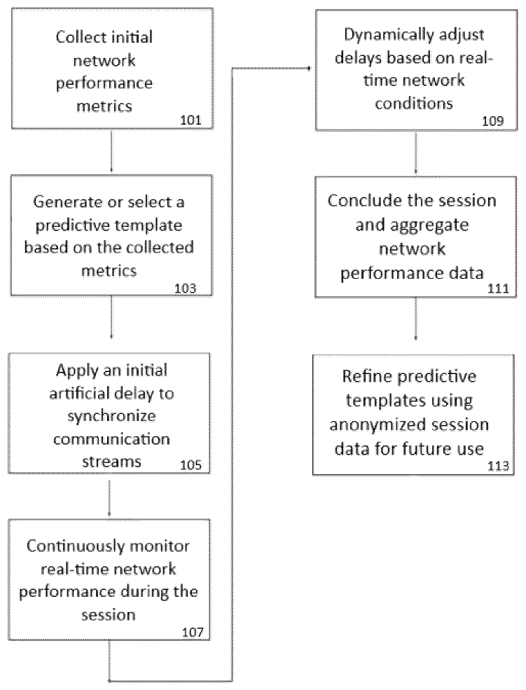

FIG. 1.101: Collect Initial Network Performance Metrics—At the initiation of a communication session, the system activates a data collection mechanism to gather real-time network performance metrics from all participating devices. These metrics include, but are not limited to, latency (the delay between data transmission and receipt), jitter (variability in packet arrival times), and packet loss (percentage of data packets lost during transmission). The data collection process is continuous and utilizes lightweight protocols to minimize overhead and avoid adding significant strain to the network. This data is temporarily stored in memory for immediate analysis and serves as the foundation for selecting or generating predictive templates tailored to the observed conditions.

FIG. 1.103: Generate or Select a Predictive Template Based on the Collected Metrics—Following the collection of initial network metrics, the system employs an analytical algorithm to determine the most suitable predictive template. If the network conditions closely align with an existing template in the database, that template is selected for use. If no matching template exists, the system generates a new one by statistically analyzing the collected metrics. This new template models anticipated network behavior during the session and includes parameters for delay synchronization and adjustment strategies. The system then stores this template in the database for future use, refining its repository of predictive models.

FIG. 1.105: Apply an Initial Artificial Delay to Synchronize Communication Streams—Using the selected or generated predictive template, the system applies an artificial delay to align communication streams (e.g., audio and video). This step ensures that all participants experience a synchronized and cohesive communication session from the outset, despite differences in device capabilities or initial network conditions. The delay is calculated based on the template's parameters, typically derived from the observed jitter and baseline latency, ensuring that the synchronization does not negatively impact user experience.

FIG. 1.107: Continuously Monitor Real-Time Network Performance During the Session—Throughout the communication session, the system continuously monitors network performance metrics in real time. A monitoring module periodically captures data on latency, jitter, and packet loss. This real-time feedback loop allows the system to detect and react to sudden changes in network conditions, such as bandwidth congestion or signal interference. The monitored data is immediately processed to determine if adjustments to the applied delay are required to maintain the quality of communication.

FIG. 1.109: Dynamically Adjust Delays Based on Real-Time Network Conditions—Based on the metrics collected during continuous monitoring, the system dynamically adjusts the applied delays to compensate for network fluctuations. The adjustments are performed incrementally to avoid abrupt changes that could disrupt the user experience. For instance, if the jitter increases unexpectedly, the system increases the delay proportionally to absorb the variations. Conversely, if the network stabilizes, the delay is gradually reduced to optimize responsiveness. These dynamic adjustments ensure that the communication session remains smooth and uninterrupted, regardless of changes in network conditions.

FIG. 1.111: Conclude the Session and Aggregate Network Performance Data—At the end of the communication session, the system terminates real-time monitoring and aggregates all collected network performance data. This data includes time-stamped metrics and adjustment logs that provide a comprehensive record of network behavior during the session. The aggregated data is anonymized to ensure compliance with privacy regulations, such as GDPR, and is securely stored in a database for subsequent analysis.

FIG. 1.113: Refine Predictive Templates Using Anonymized Session Data for Future Use—Using the anonymized and aggregated data, the system refines its predictive templates. This refinement process involves statistical analysis of the session data to identify trends and anomalies. The refined templates are updated with more accurate predictions and stored in the database, enhancing their utility for future communication sessions. This iterative refinement process enables the system to adapt to evolving network conditions and improve its latency management capabilities over time.

What is claimed is:

1. A method for reducing perceived latency in real-time communication, comprising:
a. collecting network performance metrics, including latency, jitter, and packet loss, in real time during a communication session;
b. selecting or generating a predictive template based on said metrics, where the template includes latency thresholds, jitter tolerance, initial delay settings, and dynamic adjustment rules;
c. applying an initial artificial delay at call setup to synchronize communication streams and compensate for initial network inconsistencies; and
d. dynamically adapting delays during the communication session in response to real-time variations in said metrics.

2. The method of claim 1, wherein the templates are refined post-session using anonymized network performance data to enhance future predictions, ensuring that the system continuously improves templates using global, anonymized data.

3. The method of claim 1, wherein the initial artificial delay is calculated based on template parameters derived from network conditions, and subsequent adjustments are made incrementally to maintain stability and smooth communication experiences.

4. The system of claim 1, optimized for cross-platform compatibility, capable of functioning seamlessly across FaceTime, Skype, Discord, IoT devices, and traditional telephony.

5. A system for dynamically adapting communication delays in real-time communication, comprising:
a. a network monitoring module configured to collect real-time metrics, including latency, jitter, and packet loss;
b. a predictive template system configured to store and manage templates, where templates predict network behavior and define real-time guidelines for modifying delays; and
c. a dynamic delay adaptation mechanism that incrementally adjusts delays based on said metrics during the communication session.

6. The system of claim 5, further comprising a refinement module that analyzes anonymized network data post-session to improve template accuracy for subsequent uses, ensuring adaptability to evolving network conditions.

7. The system of claim 5, wherein the predictive template system includes pre-configured templates for specific network environments, such as high-latency 4G networks, with parameters including latency thresholds, jitter tolerance, and adjustments in 10 ms increments.

8. The system of claim 5, wherein the dynamic delay adaptation mechanism operates in three phases, comprising:
a. an initialization phase where network metrics are analyzed, and an initial template is selected or generated;
b. a call phase where delays are adjusted incrementally based on real-time conditions; and
c. a post-session phase where data collected during calls refines templates for future use.

9. The system of claim 5, compliant with privacy standards such as GDPR, wherein all collected data is anonymized to ensure compliance with global privacy standards.

10. The method of claim 1, further comprising the step of integrating the system with real-time communication platforms to handle specific scenarios, including:
a. managing transitions between Wi-Fi and LTE on FaceTime;
b. synchronizing delays for group calls on Discord;
c. maintaining audio-visual quality during multi-party video conferences on Skype; and
d. adapting to signal strength variations in traditional telephony.

11. The system of claim 5, wherein predictive templates are updated using machine learning to enhance delay management and further refine adaptation rules.

12. A system for managing latency in real-time IoT communications, comprising modules for collecting network metrics, applying predictive templates, and dynamically adjusting delays to ensure low-latency communication in high-traffic IoT ecosystems.

13. The method of claim 1, wherein the system dynamically scales across platforms, ensuring seamless integration with gaming systems, virtual reality devices, and telemedicine platforms for improved communication quality under varying network conditions.
